(19) United States
(12) Patent Application Publication
(10) Pub. No.: US 2017/0046441 A1
(43) Pub. Date: Feb. 16, 2017

(54) SEARCH CONTROL SYSTEM USING MULTI-ACCESS ICON AND METHOD THEREFOR

(71) Applicants: Se-yong LEE, Seocho-gu Seoul (KR); Kyo-sik HONG, Seongnam-si Gyeonggi-do (KR); TWMOBILE CO.,LTD, Seocho-gu Seoul (KR)

(72) Inventors: Se-yong LEE, Seoul (KR); Kyo-sik HONG, Seongnam (KR); Hyun-Joo JEON, Yongin (KR)

(21) Appl. No.: 15/307,568

(22) PCT Filed: Apr. 24, 2015
(86) PCT No.: PCT/KR2015/004129

§ 371 Date: Oct. 28, 2016

(30) Foreign Application Priority Data
Apr. 30, 2014 (KR) 10-2014-0052166

(51) Int. Cl. G06F 17/30; H04L 29/08; G06Q 30/02; G06F 3/0481; G06F 3/0482

(52) U.S. Cl. CPC G06F 17/30867; G06F 3/04817; G06F 3/0482; G06Q 30/0277; H04L 67/02

(57) ABSTRACT

The present invention relates to a system for controlling mobile information output by using multi-access icons according to the embodiment of the present invention which provides, to a user terminal in a downloadable way, an application for fixedly outputting multi-access icons including a specific company name or product name in a predetermined portion of a search box to obtain a primary exposure effect of visual recognition, and enabling advertisement icons to be sequentially output, so that companies try to actively distribute applications associated with themselves, and users have no sense of refusal for advertisement or information output since they may receive more benefits by the installation of the applications and main screens of the applications are simple, and a method therefor.

### CROSS-REFERENCE TO RELATED APPLICATIONS

This application is a national Stage Patent Application of PCT International Patent Application No. PCT/KR2015/004129, filed on Apr. 24, 2015 under 35 U.S.C. §371, which claims priority of Korean Patent Application No. 10-2014-0052166, filed on Apr. 30, 2014, which are all hereby incorporated by reference in their entirety.

### TECHNICAL FIELD

The present invention relates to a system for controlling search using a multi-access icon and a method therefor, and more particularly, to a system for controlling search using a multi-access icon and a method therefor that provide, to a user terminal in a downloadable way, an application for fixedly outputting multi-access icons including a specific company name or product name in a predetermined portion of a search box to obtain a primary exposure effect of visual recognition, and enabling advertisement icons to be sequentially output.

### BACKGROUND ART

As well known in the art, in accordance with recent development of information communication techniques, a technique for information service that provides information on various fields by a wide area data communication network in real time to multiple subscribers through at least one host server has been actively developed.

In a capitalist society, a goal of a company is to make profit. In order to sell more products at a better price, it is necessary for the company to improve an image of the company or a product, and more importantly, to exposure information on the company or the product to consumers more frequently.

Further, it is urgently needed to more easily perform a series of sales from an exposure and search of the product to a payment thereof in conjunction with each other, thereby maximizing convenience for the consumers, and to expand a regular customer management that is the most important from offline to online.

However, in a case of an advertisement through a television or newspaper media that is a conventional advertisement, costs thereof are excessively large, thus small and medium-sized companies cannot afford the advertisement at all, and in a case of an internet search advertisement of large portal sites having higher power of influence and cheaper costs than the existing media, although the costs thereof are cheaper than those of the existing media, but it is still needed for the small and medium-sized companies to pay an inconsiderable amount of money for the advertisement.

Further, most of search advertisements using the existing internet portal sites is an advertisement simply using a resultant page associated with a search word, such that there is a problem of how to promote the search word including the company name or product name to customers.

That is, the search advertisements using the existing internet portal sites or advertisements using a mobile page independently built by respective companies have a problem that separate secondary advertisement for promoting the company names or product names associated with a seller should be accompanied.

In particular, even when a mobile page is built in a server of the company, a method for allowing the customers to access the mobile page is inadequate.

Further, although a loyal regular customer is equivalent to twenty normal customers, recently there is no touchpoint for providing more benefits to regular customers by means of highly addictive smartphones.

That is, even if an application that can search mobile pages of a plurality of companies has been developed, the companies should separately make advertisement for allowing the customers to search their company names or product names through the application, thus there is a problem in that the companies are not motivated to actively distribute the application.

### DISCLOSURE

### Technical Problem

In consideration of the above-mentioned circumstances, it is an object of the present invention to provide a system for controlling search using a multi-access icon and a method therefor that provide, to a user terminal in a downloadable way, an application for fixedly outputting multi-access icons including a specific company name or product name in a predetermined portion of a search box to obtain a primary exposure effect of visual recognition, and enabling advertisement icons to be sequentially output, so that companies try to actively distribute applications associated with themselves, and users have no sense of refusal for advertisement or information output since they may receive more benefits by the installation of the applications and main screens of the applications are simple.

### Technical Solution

In order to achieve the above object, according to one aspect of the present invention, there is a provided a method for controlling search using a multi-access icon, including the steps of: a) downloading and installing an icon search control application 14 in which a specific first multi-access icon 10 is fixedly displayed in a search box 8, in a user terminal 2; b) determining whether a driving control signal is applied to the icon search control application 14; c) receiving and storing, by the icon search control application 14, a second multi-access icon 70 from a multi-access search information management server 20 when the driving control signal is applied; d) outputting, by the icon search control application 14, a main screen 6 of the icon search control application in which the first and second multi-access icons 10 and 70 are displayed in the search box 8; e) determining, by the icon search control application 14, whether an operating signal of a search button 12 is applied in a state in which the first and second multi-access icons 10 and 70 are displayed in the search box 8; f) receiving, by the icon search control application 14, a mobile page matched with the second multi-access icon 70 from the multi-access search information management server 20 to output the mobile page on the screen, when the operating signal of the search button 12 is applied; g) determining, by the icon search control application 14, whether a click signal for the first or second multi-access icon 10 or 70 is applied, when the operating signal of the search button 12 is not applied; h) outputting, by the icon search control application 14, pre-stored event information 30 associated with the first or second multi-access icon 10 or 70 on the screen, when the click signal for the specific first or second multi-access icon 10 or 70 is applied; i) determining, by the icon search control application, whether a click signal for the remaining area 28 other than the first or second multi-access icon 10 or 70 is applied in the search box 8, when the click signal for the first or second multi-access icon 10 or 70 is not applied; j) removing, by the icon search control application 14, the first and second multi-access icons 10 and 70 to activate the search box 8 to be a state in which a search word is input, when the click signal for the remaining area 28 is applied; and k) receiving, by the icon search control application 14, the search word to perform a search together with the multi-access search information management server 20.

Preferably, the method further includes the steps of: before step a), accepting, by the multi-access search information management server 20, respective registration request signals for the first multi-access icon 10 that is fixed for a specific seller so as not to be replaced and the second multi-access icon 70 that is replaced with another second multi-access icon as time elapses at the time of driving the application; receiving information on the first multi-access icon 10, event information matched with the first multi-access icon 10, and URL information of a mobile page of the seller; registering, by the multi-access search information management server 20, the received information on the seller; processing, by the multi-access search information management server 20, the icon search control application 14 so that the first multi-access icon 10 is displayed in the search box 8; registering, by the multi-access search information management server 20, the processed icon search control application 14 in a downloadable way by matching the same with the information on the seller; and storing, by the multi-access search information management server 20, the second multi-access icon 70 to be transmitted to the icon search control application 14 at the time of driving the application.

Preferably, the method further includes the steps of: between step a) and step b), transmitting, by the icon search control application 14, download information to the multi-access search information management server 20; and tallying, by the multi-access search information management server 20, the download information of the application for each seller using identification information of the application.

Preferably, the method further includes the steps of: between step d) and step e), determining, by the icon search control application 14, whether a preset time elapses; and removing, by the icon search control application 14, the first multi-access icon 10 from the search box 8, wherein after step d), only the second multi-access icon 70 is displayed in the search box 8.

Preferably, steps d) to h) repeatedly perform the step of: displaying, by the icon search control application 14, a next second multi-access icon 70 in the search box 8 so as not to overlap with each other at a predetermined time interval.

Preferably, step d) includes the steps of: first outputting, by the icon search control application 14, the main screen 6 of the icon search control application in which the first multi-access icon 10 is displayed in the search box 8; and sequentially displaying a plurality of different second multi-access icons 70 in the search box 8 at a predetermined time interval after a preset time elapses.

According to one aspect of the present invention, there is a provided a system for controlling search using a multi-access icon, including: a user mobile terminal 2, in which an icon search control application 14 configured to perform a control so that first and second multi-access icons 10 and 70 are operably displayed in a search box 8 so as to output event information 30 or selectively output a mobile page 44 in which information on a company or product is published, replaces the second multi-access icon 70 with another second multi-access icon at a predetermined period, and perform communication with a multi-access search information management server 20 for outputting information associated with the first and second multi-access icons 10 and 70 on a screen, is installed; and the multi-access search information management server 20 configured to publish the icon search control application 14 in a downloadable way, and transmit the event information and the information of the mobile page output on the screen when clicking the first or second multi-access icon 10 or 70 output on a main screen 6 of the icon search control application 14 or when clicking a search button 12.

Preferably, the first and second multi-access icons 10 and 70 are icons that include a text or an image and allow a user to access event information and a mobile page associated with specific company names, product names, service names, or election candidates.

Preferably, the event information 30 includes information on the companies or discount information of the products or simple product information, information for inputting order and payment information, or hypertext information for accessing the mobile page of the companies or products.

Preferably, the icon search control application 14 is configured to control an output state of the search box so that the first multi-access icon 10 is fixedly output in the search box 8 at all times, and the second multi-access icon 70 is sequentially replaced with another second multi-access icon.

Preferably, the icon search control application 14 is configured to remove the first and second multi-access icons 10 and 70 so that another search word is input, when the remaining area 28 other than an output area of the first and second multi-access icons 10 and 70 in the search box 8 is clicked.

Preferably, the icon search control application 14 is configured to output the event information 30 on the companies or products by directly clicking the first or second multi-access icon 10 or 70 displayed in the search box 8.

Preferably, the icon search control application 14 is configured to remove the first multi-access icon 10 after a predetermined time elapses, in a state in which the first and second multi-access icons 10 and 70 are displayed in the search box 8.

Preferably, the icon search control application 14 is configured to remove the first multi-access icon 10 after a predetermined time elapses, in a state in which the first and second multi-access icons 10 and 70 are displayed in the search box 8, and periodically change the second multi-access icon 70 displayed in the search box 8 to another second multi-access icon to be output so as not to overlap with each other.

Preferably, the icon search control application 14 is configured to periodically change the second multi-access icon 70 displayed in the search box 8 to another second multi-access icon 70 to be output so as not to overlap with each other, in a state in which the first and second multi-access icons 10 and 70 are displayed in the search box 8, every time a predetermined time elapses.

Preferably, the icon search control application 14 is configured to automatically transmit information of the first or second multi-access icon 10 or 70 and the search button 12 to the multi-access search information management server 20 when clicking the search button 12, in a state in which the first or second multi-access icon 10 or 70 is displayed in the search box 8, and the multi-access search information management server 20 is configured to extract a mobile page 44 matched with the first or second multi-access icon 10 or 70 in advance and transmit the extracted mobile page.

Preferably, the multi-access search information management server 20 is configured to accept and register a distribution request signal for the icon search control application 14 in which the first multi-access icon 10 including the specific company name or product name is fixedly displayed in the search box 8, or a request signal for the second multi-access icon 70 that is randomly displayed in the search box 8 of a unspecific icon search control application 14, from an advertiser terminal 22.

Preferably, the icon search control application 14 includes: a communication module 50 configured to communicate with the multi-access search information management server 20 or a download URL relay server 24; an application identification code manager 52 configured to manage an application identification code to be included when data is transmitted to a remote server; an icon publication information manager 57 configured to manage publication information of the icon search control application 14 in which the first multi-access icon 10 is fixed in the search box 8; a click position sensing unit 58 configured to determine whether the search button 12, the remaining area other than the first multi-access icon 10, or the first or second multi-access icon 10 or 70 is clicked, in a state in which the first and second multi-access icons 10 and 70 are displayed in the search box 8; a search information relay processor 60 which relays to transmit a search word input in the search box 8 to the multi-access search information management server 20, and receive a result value thereof; an event window control information transmitter 62 configured to control a menu published in the event information that is output by clicking the first or second multi-access icon 10 or 70, or transmit input information input in an input window to the multi-access search information management server; a first multi-access icon output controller 64 configured to control the first multi-access icon 10 to be output in the search box 8, and control the first multi-access icon 10 to be removed, when the remaining area 28 in the search box 8 is clicked; and a controller 66 configured to control the respective units so as to output data by detecting a click on the first multi-access icon 10 that is fixedly output in the search box 8 for each application, a plurality of the second multi-access icons 70 that is sequentially output, and the remaining area 28 other than the first multi-access icon 10, and control first and second mobile pages so as to be output by clicking the search button in a state in which the first and second multi-access icons 10 and 70 are displayed in the search box 8.

Preferably, the icon search control application 14 further includes: a seller event information storage unit 54 configured to receive event information of a seller that is output on the screen when the first and second multi-access icons 10 and 70 are clicked at the time of driving the application from the multi-access search information management server 20, and store the received event information; and a data update unit 56 configured to update the event information of the seller.

Preferably, the icon search control application 14 further includes: a second multi-access icon output controller 65 configured to control the second multi-access icon 70 so as to be output in the search box 8, control the second multi-access icon 70 so as to be removed, when clicking the remaining area 28 of the search box 8, and automatically replace the second multi-access icon 70 with another second multi-access icon 70 after a predetermined time elapses.

### Advantageous Effects

In the system for controlling search using a multi-access icon and a method therefor according to the present invention, a company providing an application may actively distribute the application since sellers are active in distributing the application because their company names or product names are displayed in the search box in a form of an icon, and the sellers may fixedly display their company names or product names in the search box, thus significant advertisement effect may be expected, and the icon is displayed in the search box, such that the icon may receive a lot of attention. Further, when clicking the multi-access icon, consumers may have more benefits for the access. Accordingly, economic advantages, commercial benefits, and convenience are significantly increased.

### DESCRIPTION OF DRAWINGS

FIG. 1 is a diagram schematically illustrating a configuration of a system for controlling search using a multi-access icon according to an embodiment of the present invention.

FIG. 2 is a diagram illustrating an access state of a multi-access icon displayed through the system for controlling mobile information output by using multi-access icons according to the embodiment of the present invention.

FIG. 3 is a block diagram illustrating a configuration of an icon search control application included in the system for controlling mobile information output by using multi-access icons according to the embodiment of the present invention.

FIG. 4 is a flow chart illustrating a signal flow of the system for controlling mobile information output by using multi-access icons according to the embodiment of the present invention.

### BEST MODE

Hereinafter, the present invention will be described in detail with reference to the accompanying drawings.

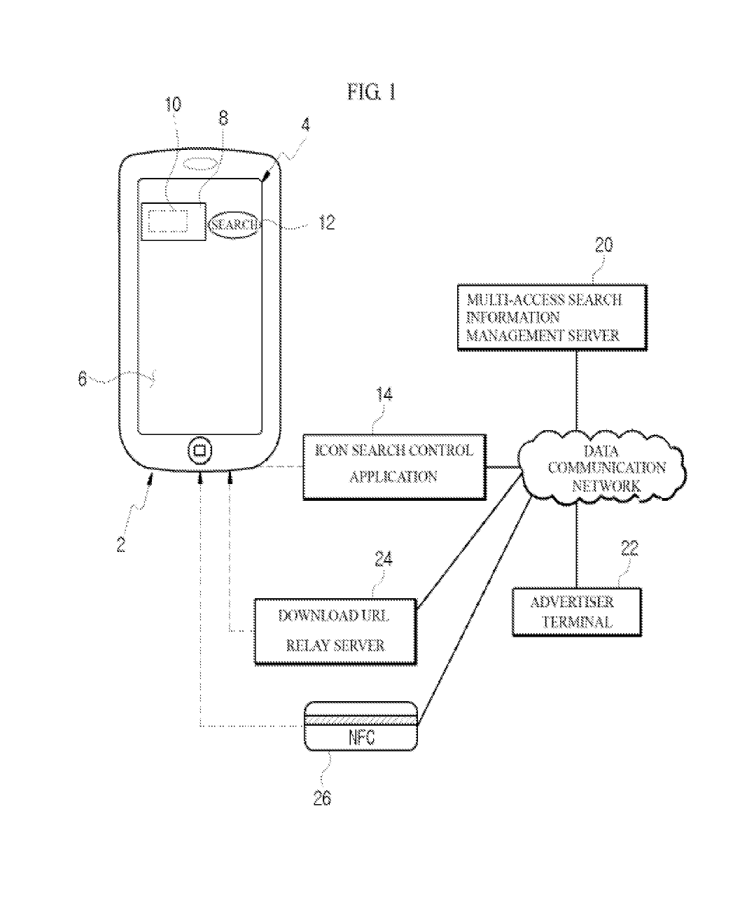

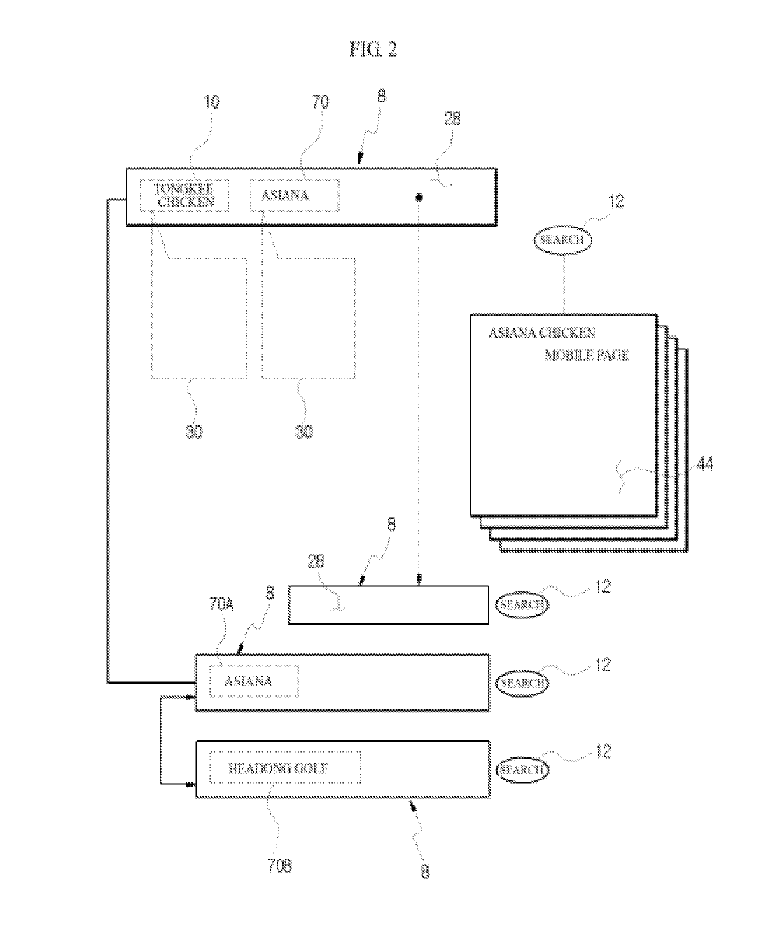

FIG. 1 is a diagram schematically illustrating a configuration of a system for controlling mobile information output by using multi-access icons according to an embodiment of the present invention, and FIG. 2 is a diagram illustrating an access state of a multi-access icon displayed through the system for controlling mobile information output by using multi-access icons according to the embodiment of the present invention.

Referring to FIGS. 1 and 2, the system for controlling mobile information output by using multi-access icons according to the embodiment of the present invention may provide, to a user terminal in a downloadable way, an application for fixedly outputting multi-access icons including a specific company name or product name in a predetermined portion of a search box to obtain a primary exposure effect of visual recognition, and enabling advertisement icons to be sequentially output, so that companies try to actively distribute applications associated with themselves, and users have no sense of refusal for advertisement or information output since they may receive more benefits by the installation of the applications and main screens of the applications are simple.

The system for controlling mobile information output by using multi-access icons according to the embodiment of the present invention is a system for displaying multi-access icons capable of outputting an advertisement and event information by using a search box of a search application for searching mobile pages of a plurality of companies, in which a plurality of multi-access icons are displayed, thereby improving an information output effect and convenience.

To this end, the system for controlling mobile information output by using multi-access icons according to the embodiment of the present invention includes the user mobile terminal 2, in which an icon search control application 14 configured to perform a control so that first and second multi-access icons 10 and 70 are operably displayed in a search box 8 so as to output event information 30 or selectively output a mobile page 44 in which information on a company or product is published, replaces the second multi-access icon 70 with another second multi-access icon at a predetermined period, and perform communication with a multi-access search information management server 20 for outputting the information associated with the first and second multi-access icons 10 and 70 on a screen, is installed; and the multi-access search information management server 20 configured to publish the icon search control application 14 in a downloadable way, and transmit the event information and the information of the mobile page output on the screen when clicking the first or second multi-access icon 10 or 70 output on a main screen 6 of the icon search control application 14 or when clicking a search button 12.

In this case, the first and second multi-access icons 10 and 70 are icons that include a text or an image and allow a user to access event information and a mobile page associated with the specific company names, product names, service names, or election candidates.

Further, the event information 30 includes information on the companies or discount information of the products or simple product information, information for inputting order and payment information, or hypertext information for accessing the mobile page of the companies or products.

In addition, the icon search control application 14 is configured to control an output state of the search box so that the first multi-access icon 10 is fixedly output in the search box 8 at all times, and the second multi-access icon 70 is sequentially replaced with another second multi-access icon.

Meanwhile, the icon search control application 14 is configured to remove the first and second multi-access icons 10 and 70 so that another search word may be input, when the remaining area 28 other than the output area of the first and second multi-access icons 10 and 70 in the search box 8 is clicked.

Preferably, the icon search control application 14 is configured to output the event information 30 of the companies or products by directly clicking the first or second multi-access icon 10 or 70 displayed in the search box 8.

That is, the system for controlling mobile information output by using multi-access icons according to the embodiment of the present invention is a system distributing an icon search control application so that the first and second multi-access icons 10 and 70 for outputting the event information 30 or the mobile page 44 on which information on the companies or products is published are displayed in the search box 8 output on the screen of the user mobile terminal 2.

That is, the inventive system is a system distributing the icon search control application so that the first and second multi-access icons 10 and 70 for outputting the event information 30 or the mobile page 44 on which the information on the companies or products is published is displayed in the search box 8 output on the screen of the user mobile terminal 2.

More preferably, the first multi-access icon 10 is fixedly displayed in the search box 8 of any one icon search control application 14, and the second multi-access icon 70 is displayed to be adjacent to the first multi-access icon 10 and is replaced with another second multi-access icon 70 so as not to overlap with each other after a predetermined period.

That is, to distribute the icon search control application 14 capable of searching mobile pages for a plurality of companies or products so that the icon search control application may be downloaded and installed in the user terminal 2, the system for controlling mobile information output by using multi-access icons according to the embodiment of the present invention may distribute the icon search control application 14 by fixing a specific first multi-access icon 10 to be output all the times in the search box 8 that is output on the main screen 6 of the icon search control application.

Then, a company name or product name of the seller is produced as the first multi-access icon 10 which is in a form of an icon, and the first multi-access icon is displayed in the search box of the icon search control application 14 to be distributed, thus an advertisement effect is significant increased, and the users may access the information on the company or product, thereby more increasing the advertisement effect. As a result, the seller may make an effort to distribute the icon search control application 14.

For example, a user may download and install the icon search control application 14 in the user terminal 2. The user may install an icon search control application 14 in which a first multi-access icon 10 of “Tongkee Chicken (registered trademark)” is fixedly output in the search box 8, and may also install an icon search control application 14 in which a first multi-access icon 10 of “iPhone (registered trademark)” is fixedly output in the search box 8.

Herein, when the user clicks the search button 12 in a state in which the first multi-access icon 10 of “Tongkee Chicken” is output in the search box 8, a mobile page 44 of “Tongkee Chicken” is output on the screen.

Further, when the user directly clicks the first multi-access icon 10 of “Tongkee Chicken” output in the search box 8, the event information 30 registered by a seller in the multi-access search information management server 20 is output.

Meanwhile, a plurality of the second multi-access icons 70 are received from the multi-access search information management server 20 and stored at the time of driving the application, are output in the search box 8 to be adjacent to the first multi-access icon 10, and are sequentially updated at a predetermined time interval so as not to overlap with each other.

In addition, in a case in which the user tends to search another search word using the icon search control application 14, when the user clicks the remaining area 28 other than the first and second multi-access icons 10 and 70 in the search box 8, the first and second multi-access icons 10 and 70 are removed from the search box 8, such that another search word may be input.

Further, the first and second multi-access icons 10 and 70 may also output the mobile page 44 associated with the multi-access icon 10, and output the event information 30 such as the discount information on the screen, thus the user may access multiple information through a single icon.

Further, the first multi-access icon 10 may also output the mobile page 44 associated with the first multi-access icon 10, and output the event information 30 such as the discount information on the screen, thus the user may access multiple information through a single icon.

Meanwhile, the icon search control application 14 may be configured to remove the first multi-access icon 10 after a predetermined time elapses, in a state in which the first and second multi-access icons 10 and 70 are displayed in the search box 8.

That is, to control the output of the first and second multi-access icons 10 and 70 in the search box 8, the icon search control application 14 may use several methods. First, in the state in which the first and second multi-access icons 10 and 70 are displayed in the search box 8 when the icon search control application 14 is initially driven, the first multi-access icon 10 may be removed after a predetermined time elapses, and the second multi-access icon 70 may be continuously changed.

Further, in the state in which the first and second multi-access icons 10 and 70 are displayed in the search box 8 and the first multi-access icon 10 is fixedly maintained, the second multi-access icon 70 may be continuously changed.

Further, in the state in which the first multi-access icon 10 is displayed in the search box 8 when the application is initially driven, the first multi-access icon 10 may be removed after a predetermined time elapses, and the second multi-access icon 70 may be newly displayed and continuously changed at a predetermined time interval.

The advertisement effect of the first multi-access icon 10 is better than that of the second multi-access icon 70, and when a plurality of sellers participate, publication of an icon may be put up at auction, or advertisement costs may be flat rate or may be determined based on exposure frequency, the number of download of the applications, etc.

Meanwhile, the icon search control application 14 is configured to automatically transmit information of the first or second multi-access icon 10 or 70 and the search button 12 to the multi-access search information management server 20 when clicking the search button 12, in a state in which the first or second multi-access icon 10 or 70 is displayed in the search box 8, and the multi-access search information management server 20 is configured to extract the mobile page 44 matched with the first or second multi-access icon 10 or 70 in advance and transmit the extracted mobile page.

Further, preferentially, the multi-access search information management server 20 is configured to accept and register a distribution request signal for the icon search control application 14 in which the first multi-access icon 10 including the specific company name or product name is fixedly displayed in the search box 8, or a request signal for the second multi-access icon 70 that is randomly displayed in the search box 8 of a unspecific icon search control application 14, from an advertiser terminal 22.

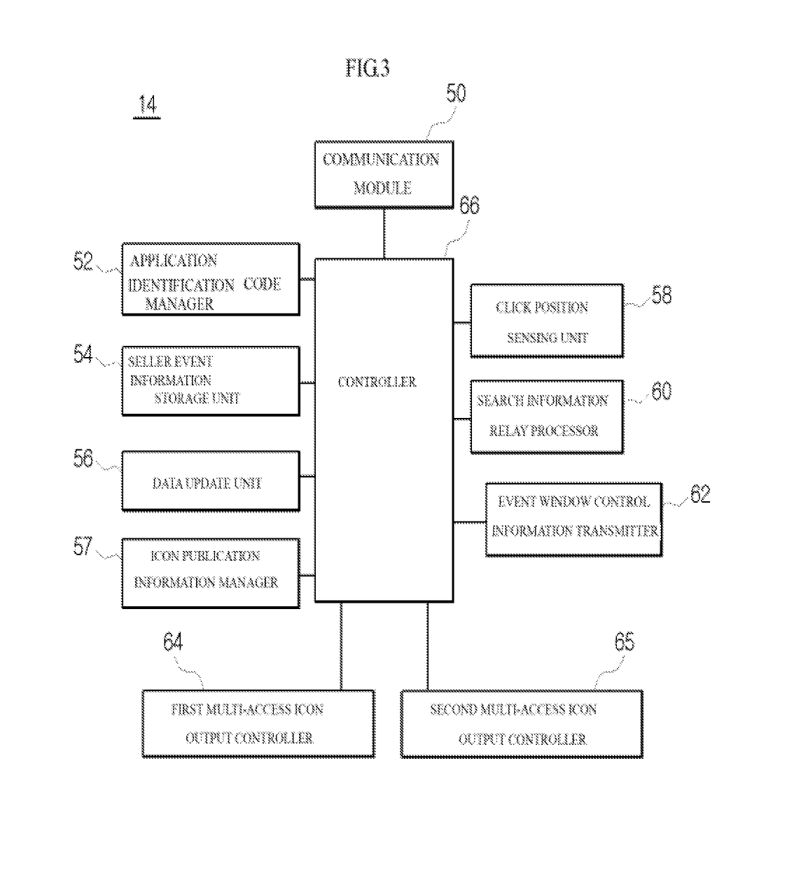

FIG. 3 is a block diagram illustrating a configuration of an icon search control application included in the system for controlling mobile information output by using multi-access icons according to the embodiment of the present invention.

Referring to FIG. 3, the icon search control application 14 includes: a communication module 50 configured to communicate with the multi-access search information management server 20 or a download URL relay server 24; an application identification code manager 52 configured to manage an application identification code to be included when data is transmitted to a remote server; an icon publication information manager 57 configured to manage publication information of the icon search control application 14 in which the first multi-access icon 10 is fixed in the search box 8; and a click position sensing unit 58 configured to determine whether the search button 12, the remaining area other than the first multi-access icon 10, or the first or second multi-access icon 10 or 70 is clicked, in a state in which the first and second multi-access icons 10 and 70 are displayed in the search box 8.

In addition, the icon search control application 14 includes: a search information relay processor 60 which relays to transmit the search word input in the search box 8 to the multi-access search information management server 20, and receive a result value thereof; an event window control information transmitter 62 configured to control a menu published in the event information that is output by clicking the first or second multi-access icon 10 or 70, or transmit input information input in an input window to the multi-access search information management server; a first multi-access icon output controller 64 configured to control the first multi-access icon 10 so as to be output in the search box 8, and control the first multi-access icon 10 so as to be removed, when the remaining area 28 in the search box 8 is clicked; and a controller 66 configured to control the respective units so as to output data by detecting a click on the first multi-access icon 10 that is fixedly output in the search box 8 for each application, a plurality of the second multi-access icons 70 that is sequentially output, and the remaining area 28 other than the first multi-access icon 10, and control first and second mobile pages so as to be output by clicking the search button in a state in which the first and second multi-access icons 10 and 70 are displayed in the search box 8.

Further, the icon search control application 14 further includes a seller event information storage unit 54 configured to receive event information of a seller that is output on the screen when the first and second multi-access icons 10 and 70 are clicked at the time of driving the application from the multi-access search information management server 20, and store the received event information; and a data update unit 56 configured to update the event information of the seller.

In addition, the icon search control application 14 further includes a second multi-access icon output controller 65 configured to control the second multi-access icon 70 so as to be output in the search box 8, control the second multi-access icon 70 so as to be removed, when clicking the remaining area 28 of the search box 8, and automatically replace the second multi-access icon 70 with another second multi-access icon 70 after a predetermined time elapses.

Functions and operations of the system for controlling mobile information output by using multi-access icons according to the embodiment of the present invention having the above-described configuration will be described in detail with reference to the accompanying drawings.

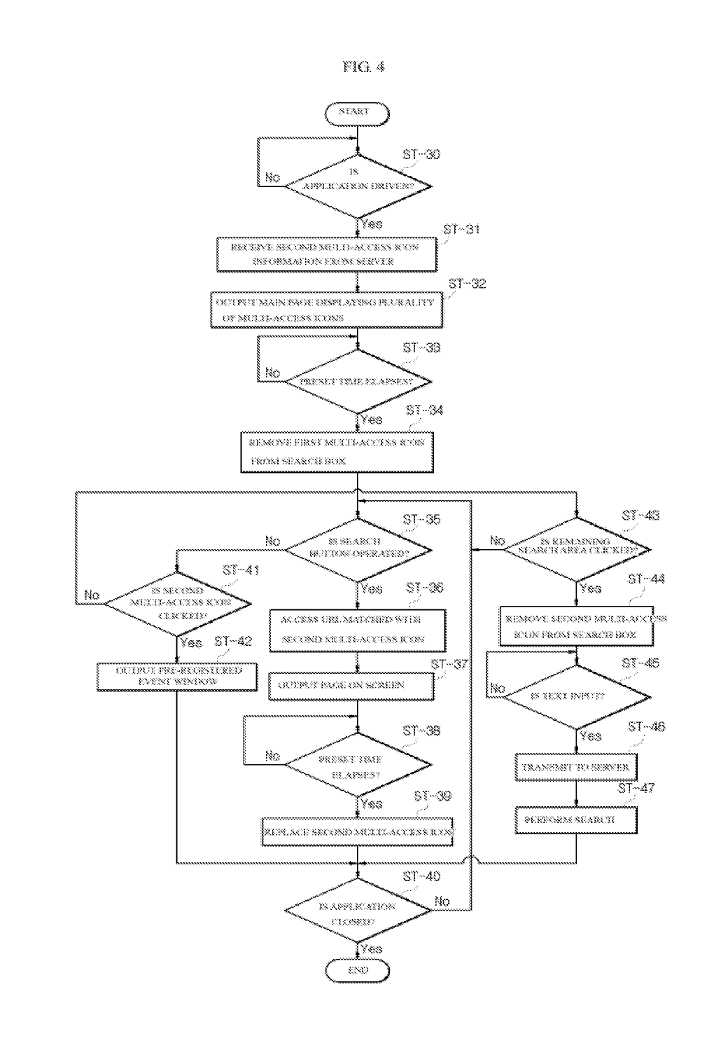

FIG. 4 is a flow chart illustrating a signal flow of the system for controlling mobile information output by using multi-access icons according to the embodiment of the present invention.

First, before step a), the multi-access search information management server 20 accepts respective registration request signals for the first multi-access icon 10 that is fixed for a specific seller so as not to be replaced and the second multi-access icon 70 that is replaced with another second multi-access icon as time elapses at the time of driving the application.

Further, the multi-access search information management server 20 receives information on the first multi-access icon 10, event information matched with the first multi-access icon 10, and URL information of a mobile page of the seller, and registers the received information on the seller.

Further, the multi-access search information management server 20 processes the icon search control application 14 so that the first multi-access icon 10 is displayed in the search box 8; and the multi-access search information management server 20 registers the processed icon search control application 14 in a downloadable way by matching the same with the information on the seller in sequence.

Next, the multi-access search information management server 20 stores the second multi-access icon 70 to be transmitted to the icon search control application 14 at the time of driving the application.

Further, a) the icon search control application 14, in which a specific first multi-access icon 10 is fixedly displayed in the search box 8, is downloaded and installed in the user terminal 2.

Between step a) and step b), a step of transmitting, by the icon search control application 14, download information to the multi-access search information management server 20; and a step of tallying, by the multi-access search information management server 20, the download information of the application for each seller using identification information of the application, are further included.

Further, b) the icon search control application 14 determines whether a driving control signal is applied thereto.

Next, c) when the driving control signal is applied, the icon search control application 14 receives and stores the second multi-access icon 70 from the multi-access search information management server 20, and d) the icon search control application 14 outputs the main screen 6 of the icon search control application in which the first and second multi-access icons 10 and 70 are displayed in the search box 8.

Herein, step d) includes a step of first outputting, by the icon search control application 14, the main screen 6 of the icon search control application in which the first multi-access icon 10 is displayed in the search box 8; and a step of sequentially displaying a plurality of different second multi-access icons 70 in the search box 8 at a predetermined time interval after a preset time elapses.

Next, e) the icon search control application 14 determines whether an operating signal of the search button 12 is applied in the state in which the first and second multi-access icons 10 and 70 are displayed in the search box 8.

Then, f) when the operating signal of the search button 12 is applied, the icon search control application 14 receives a mobile page matched with the second multi-access icon 70 from the multi-access search information management server 20 to output the mobile page on the screen.

Next, g) when the operating signal of the search button 12 is not applied, the icon search control application 14 determines whether a click signal for the first or second multi-access icon 10 or 70 is applied.

h) When the click signal for the specific first or second multi-access icon 10 or 70 is applied, the icon search control application 14 outputs pre-stored event information 30 associated with the first or second multi-access icon 10 or 70 on the screen.

Meanwhile, i) when the click signal for the first or second multi-access icon 10 or 70 is not applied, the icon search control application determines whether a click signal for the remaining area 28 other than the first or second multi-access icon 10 or 70 is applied in the search box 8.

Further, j) when the click signal for the remaining area 28 is applied, the icon search control application 14 removes the first and second multi-access icons 10 and 70 to activate the search box 8 to be a state in which a search word may be input.

Next, the inventive system includes step k) that the icon search control application 14 receives the search word and performs a search together with the multi-access search information management server 20.

Meanwhile, between step d) and step e), a step of determining, by the icon search control application 14, whether a preset time elapses; and a step of removing, by the icon search control application 14, the first multi-access icon 10 from the search box 8 are further included, and after step d), only the second multi-access icon 70 is displayed in the search box 8.

Preferably, steps d) to step h) repeatedly perform the step of displaying, by the icon search control application 14, a next second multi-access icon 70 in the search box 8 so as not to overlap with each other at a predetermined time interval.

Accordingly, in the system for controlling search using a multi-access icon according to the embodiment of the present invention, a company providing an application may actively distribute the application since the sellers are active in distributing the application because their company names or product names are displayed in the search box in a form of an icon, and the sellers may fixedly display their company names or product names in the search box, thus significant advertisement effect may be expected. Further, when clicking the multi-access icon, consumers may have more benefits for the access. Accordingly, economic advantages, commercial benefits, and convenience are significant.

Meanwhile, the system for controlling search using a multi-access icon and the method therefor according to the embodiments of the present invention are not limited to above described embodiments, but may be variously modified without departing from the technical gist of the present invention.

### DESCRIPTION OF REFERENCE NUMERALS

2: user terminal
6: main screen of application
8: search box
10: first multi-access icon
12: search button
14: icon search control application
20: multi-access search information management server
22: advertiser terminal
70: second multi-access icon

### INDUSTRIAL APPLICABILITY

1. A method for controlling search using a multi-access icon, comprising the steps of:
downloading and installing an icon search control application in which a specific first multi-access icon is fixedly displayed in a search box, in a user terminal;
determining whether a driving control signal is applied to the icon search control application;
receiving and storing, by the icon search control application, a second multi-access icon from a multi-access search information management server when the driving control signal is applied;
outputting, by the icon search control application, a main screen of the icon search control application in which the first and second multi-access icons are displayed in the search box;
determining, by the icon search control application, whether an operating signal of a search button is applied in a state in which the first and second multi-access icons are displayed in the search box;
receiving, by the icon search control application, a mobile page matched with the second multi-access icon from the multi-access search information management server to output the mobile page on the screen, when the operating signal of the search button is applied;
determining, by the icon search control application, whether a click signal for the first or second multi-access icon is applied, when the operating signal of the search button is not applied;
outputting, by the icon search control application, pre-stored event information associated with the first or second multi-access icon on the screen, when the click signal for the specific first or second multi-access icon is applied;
determining, by the icon search control application, whether a click signal for the remaining area other than the first or second multi-access icon is applied in the search box, when the click signal for the first or second multi-access icon is not applied;
removing, by the icon search control application, the first and second multi-access icons to activate the search box to be a state in which a search word is input, when the click signal for the remaining area is applied; and
receiving, by the icon search control application, the search word to perform a search together with the multi-access search information management server.

2. The method of claim 1, further comprising the steps of: before step a),
accepting, by the multi-access search information management server, respective registration request signals for the first multi-access icon that is fixed for a specific seller so as not to be replaced and the second multi-access icon that is replaced with another second multi-access icon as time elapses at the time of driving the application;
receiving information on the first multi-access icon, event information matched with the first multi-access icon, and URL information of a mobile page of the seller;
registering, by the multi-access search information management server, the received information on the seller;
processing, by the multi-access search information management server, the icon search control application so that the first multi-access icon is displayed in the search box;
registering, by the multi-access search information management server, the processed icon search control application in a downloadable way by matching the same with the information on the seller; and
storing, by the multi-access search information management server, the second multi-access icon to be transmitted to the icon search control application at the time of driving the application.

3. The method of claim 1, further comprising the steps of: between step a) and step b),
transmitting, by the icon search control application, download information to the multi-access search information management server; and
tallying, by the multi-access search information management server, the download information of the application for each seller using identification information of the application.

4. The method of claim 1, further comprising the steps of: between step d) and step e),
determining, by the icon search control application, whether a preset time elapses; and
removing, by the icon search control application, the first multi-access icon from the search box, wherein after step d), only the second multi-access icon is displayed in the search box.

5. The method of claim 1, wherein steps d) to h) repeatedly perform the step of:
displaying, by the icon search control application, a next second multi-access icon in the search box so as not to overlap with each other at a predetermined time interval.

6. The method of claim 1, wherein step d) comprises the steps of: first outputting, by the icon search control application, the main screen of the icon search control application in which the first multi-access icon is displayed in the search box; and
sequentially displaying a plurality of different second multi-access icons in the search box at a predetermined time interval after a preset time elapses.

7. A system for controlling search using a multi-access icon, comprising:
a user mobile terminal, in which an icon search control application configured to perform a control so that first and second multi-access icons are operably displayed in a search box so as to output event information or selectively output a mobile page in which information on a company or product is published, replaces the second multi-access icon with another second multi-access icon at a predetermined period, and perform communication with a multi-access search information management server for outputting information associated with the first and second multi-access icons on a screen, is installed; and
the multi-access search information management server configured to publish the icon search control application in a downloadable way, and transmit the event information and the information of the mobile page output on the screen when clicking the first or second multi-access icon output on a main screen of the icon search control application or when clicking a search button.

8. The system of claim 7, wherein the first and second multi-access icons are icons that include a text or an image and allow a user to access event information and a mobile page associated with specific company names, product names, service names, or election candidates.

9. The system of claim 7, wherein the event information includes information on the companies or discount information of the products or simple product information, information for inputting order and payment information, or hypertext information for accessing the mobile page of the companies or products.

10. The system of claim 7, wherein the icon search control application is configured to control an output state of the search box so that the first multi-access icon is fixedly output in the search box at all times, and the second multi-access icon is sequentially replaced with another second multi-access icon.

11. The system of claim 7, wherein the icon search control application is configured to remove the first and second multi-access icons so that another search word is input, when the remaining area other than an output area of the first and second multi-access icons in the search box is clicked.

12. The system of claim 7, wherein the icon search control application is configured to output the event information on the companies or products by directly clicking the first or second multi-access icon displayed in the search box.

13. The system of claim 7, wherein the icon search control application is configured to remove the first multi-access icon after a predetermined time elapses, in a state in which the first and second multi-access icons are displayed in the search box.

14. The system of claim 7, wherein the icon search control application is configured to remove the first multi-access icon after a predetermined time elapses, in a state in which the first and second multi-access icons are displayed in the search box, and periodically change the second multi-access icon displayed in the search box to another second multi-access icon to be output so as not to overlap with each other.

15. The system of claim 7, wherein the icon search control application is configured to periodically change the second multi-access icon displayed in the search box to another second multi-access icon to be output so as not to overlap with each other, in a state in which the first and second multi-access icons are displayed in the search box, every time a predetermined time elapses.

16. The system of claim 7, wherein the icon search control application is configured to automatically transmit information of the first or second multi-access icon and the search button to the multi-access search information management server when clicking the search button, in a state in which the first or second multi-access icon is displayed in the search box, and
the multi-access search information management server is configured to extract a mobile page matched with the first or second multi-access icon in advance and transmit the extracted mobile page.

17. The system of claim 7, wherein the multi-access search information management server is configured to accept and register a distribution request signal for the icon search control application in which the first multi-access icon including the specific company name or product name is fixedly displayed in the search box, or a request signal for the second multi-access icon that is randomly displayed in the search box of a unspecific icon search control application, from an advertiser terminal.

18. The system of claim 7, wherein the icon search control application comprises:
a communication module configured to communicate with the multi-access search information management server or a download URL relay server;
an application identification code manager configured to manage an application identification code to be included when data is transmitted to a remote server;
an icon publication information manager configured to manage publication information of the icon search control application in which the first multi-access icon is fixed in the search box;
a click position sensing unit 58 configured to determine whether the search button, the remaining area other than the first multi-access icon, or the first or second multi-access icon is clicked, in a state in which the first and second multi-access icons are displayed in the search box;
a search information relay processor which relays to transmit a search word input in the search box to the multi-access search information management server, and receive a result value thereof;
an event window control information transmitter configured to control a menu published in the event information that is output by clicking the first or second multi-access icon, or transmit input information input in an input window to the multi-access search information management server;
a first multi-access icon output controller configured to control the first multi-access icon to be output in the search box, and control the first multi-access icon to be removed, when the remaining area in the search box is clicked; and
a controller configured to control the respective units so as to output data by detecting a click on the first multi-access icon that is fixedly output in the search box for each application, a plurality of the second multi-access icons that is sequentially output, and the remaining area other than the first multi-access icon, and control first and second mobile pages so as to be output by clicking the search button in a state in which the first and second multi-access icons are displayed in the search box.

19. The system of claim 7, wherein the icon search control application further comprises:
a seller event information storage unit configured to receive event information of a seller that is output on the screen when the first and second multi-access icons are clicked at the time of driving the application from the multi-access search information management server, and store the received event information; and
a data update unit configured to update the event information of the seller.

20. The system of claim 7, wherein the icon search control application further comprises:
a second multi-access icon output controller configured to control the second multi-access icon so as to be output in the search box, control the second multi-access icon so as to be removed, when clicking the remaining area of the search box, and automatically replace the second multi-access icon with another second multi-access icon after a predetermined time elapses.
